(19) United States
(12) Patent Application Publication
(10) Pub. No.: US 2021/0339455 A1
(43) Pub. Date: Nov. 4, 2021

(54) INCREASING TRANSPARENCY OF NANOFIBER SHEETS

(71) Applicant: LINTEC OF AMERICA, INC., Richardson, TX (US)

(72) Inventor: Jaeah LEE, Richardson, TX (US)

(73) Assignee: LINTEC OF AMERICA, INC., Richardson, TX (US)

(21) Appl. No.: 17/285,982

(22) PCT Filed: Sep. 27, 2019
(86) PCT No.: PCT/US2019/053406

§ 371 Date: Apr. 16, 2021

Related U.S. Application Data
(60) Provisional application No. 62/747,995, filed on Oct. 19, 2018.

(51) Int. Cl. B29C 55/04; B32B 5/12; C01B 32/168

(52) U.S. Cl. CPC B29C 55/04; B32B 5/12; C01B 32/168; B29K 2995/0026; B82Y 40/00; C01B 2202/08; C01B 2202/06; C01P 2004/02; C01P 2004/03; B32B 2307/412

(57) ABSTRACT

Methods for increasing transparency of a nanofiber sheet to many wavelengths of radiation, including those wavelengths within the visible spectrum, are described. These techniques include straining a nanofiber sheet so as to increase its width.

### TECHNICAL FIELD

The present disclosure relates generally to nanofiber sheets. Specifically, the present disclosure relates to increasing transparency of nanofiber sheets.

### BACKGROUND

Nanofiber forests, composed of both single wall and multiwalled nanotubes, can be drawn into nanofiber ribbons or sheets. In its pre-drawn state, the nanofiber forest comprises a layer (or several stacked layers) of nanofibers that are parallel to one another and perpendicular to a surface of a growth substrate. When drawn into a nanofiber sheet, the orientation of the nanofibers changes from perpendicular to parallel relative to the surface of the growth substrate. The nanotubes in the drawn nanofiber sheet connect to one another in an end-to-end configuration to form a continuous sheet in which a longitudinal axis of the nanofibers is parallel to a plane of the sheet (i.e., parallel to both of the first and second major surfaces of the nanofiber sheet). The nanofiber sheet can be treated in any of a variety of ways, including spinning the nanofiber sheet into a nanofiber yarn.

### SUMMARY

Example 1 is a method comprising drawing a first nanofiber sheet from a nanofiber forest, the first nanofiber sheet having a fixed end integral with the nanofiber forest and a free end opposite the fixed end, wherein a plurality of nanofibers of the first nanofiber sheet are aligned with a drawing direction of the first nanofiber sheet; attaching a strain element to the free end; applying strain to the free end by elongating the strain element in a direction not parallel to the alignment of the nanofibers; attaching the strained free end of the nanofiber sheet to a support, the support maintaining the applied strain in the first nanofiber sheet; removing the first nanofiber sheet from the nanofiber forest; and stacking a second nanofiber sheet on the first nanofiber sheet.

Example 2 includes the subject matter of Example 1, further comprising drawing the second nanofiber sheet from the nanofiber forest, the second nanofiber sheet having a second fixed end integral with the nanofiber forest and a second free end opposite the second fixed end, wherein a plurality of nanofibers of the second nanofiber sheet are aligned with the drawing direction of the second nanofiber sheet; attaching the strain element to the second free end; applying strain to the second free end by elongating the strain element in a second direction not parallel to the orientation of the nanofibers; attaching the second strained, free end of the second nanofiber sheet to a second support, the second support maintaining the applied strain in the second nanofiber sheet; and removing the second nanofiber sheet from the nanofiber forest.

Example 3 includes the subject matter of either of Examples 1 or 2, further comprising forming a plurality of gaps in one or both of the first nanofiber sheet and the second nanofiber sheet in response to applying the strain.

Example 4 includes the subject matter of Example 3, wherein an average gap size of the gaps is from 8 microns on a side to 45 microns on a side.

Example 5 includes the subject matter of any of the preceding Examples, wherein: applying the strain to the first nanofiber sheet and the second nanofiber sheet comprises straining each sheet by a factor of 3; and a transparency of the stacked first nanofiber sheet and the second nanofiber sheet to radiation in the visible spectrum is 90%.

Example 6 includes the subject matter of any of the preceding Examples, wherein a transparency of the stack of the first nanofiber sheet and the second nanofiber sheet to radiation having a wavelength of 550 nm is from 72% to 88%.

Example 7 includes the subject matter of any of the preceding Examples, wherein the first nanofiber sheet and the second nanofiber sheet are stacked relative to have their corresponding nanofiber alignment directions not parallel to one another.

Example 8 includes the subject matter of any of the preceding Examples, wherein an angle between nanofiber alignment directions of the first nanofiber sheet and the second nanofiber sheet are from 45° to 135°, excluding 0°.

Example 9 includes the subject matter of Example 1, wherein the second nanofiber sheet is in an as-drawn state.

Example 10 includes the subject matter of Example 9, further comprising densifying the second nanofiber sheet by exposing the second nanofiber sheet to a solvent and removing the solvent before the stacking.

Example 11 is a method comprising drawing a nanofiber sheet from a nanofiber forest, the nanofiber sheet having a fixed end integral with the nanofiber forest and a free end opposite the fixed end, wherein a plurality of nanofibers of the nanofiber sheet are aligned in a direction parallel to a drawing direction of the nanofiber sheet; attaching a strain element to the free end; applying strain to the free end by elongating the strain element in a direction not parallel to the alignment of the nanofibers; and attaching the strained, free end of the nanofiber sheet to a support, the support maintaining the applied strain in the nanofiber sheet.

Example 12 includes the subject matter of Example 11, further comprising removing the strain element from the strained free end.

Example 13 includes the subject matter of either of Examples 11 or 12, further comprising applying the method of claim 11 to the fixed end of the nanofiber sheet.

Example 14 includes the subject matter of any of Examples 11-13, further comprising severing the fixed end from the nanofiber forest after applying the strain to the fixed end.

Example 15 includes the subject matter of Example 14, wherein the strain is applied in a direction from 45° to 135° relative to the direction of alignment of the nanofibers within the nanofiber sheet.

Example 16 includes the subject matter of any of Examples 11-15, wherein the nanofiber sheet has a first width prior to straining and a second width after straining, the second width greater than the first width.

Example 17 includes the subject matter of Example 16, wherein the second width is from 2.5 times to 3 times the first width.

Example 18 includes the subject matter of Example 16, wherein a transparency to radiation having a wavelength of 550 nm is at least 80%.

### BRIEF DESCRIPTION OF THE DRAWINGS

FIG. 1 is a photomicrograph of an example forest of nanofibers on a substrate, in an embodiment.

FIG. 2 is a schematic illustration of an example reactor for nanofiber growth, in an embodiment.

FIG. 3 is an illustration of a nanofiber sheet that identifies relative dimensions of the sheet and schematically illustrates nanofibers within the sheet aligned end-to-end in a plane parallel to a surface of the sheet, in an embodiment.

FIG. 4 is an SEM photomicrograph is an image of a nanofiber sheet being laterally drawn from a nanofiber forest, the nanofibers aligning from end-to-end as schematically.

FIG. 5 is a flow diagram of an example method for increasing transparency of nanofiber sheet, in an example of the present disclosure.

FIGS. 6A-6F illustrate various stages of a method for increasing transparency of a nanofiber sheet by performing the method depicted in FIG. 5, in examples of the present disclosure.

FIG. 7 shows experimental results depicting 1× and 20× images of two nanofiber sheets, each stretched to three times (3×) the width of the as-drawn sheet and stacked so that individual nanofiber orientations were at 90° to one another, in an example of the present disclosure.

FIG. 8 shows images of the sample shown in FIG. 7 at 20× magnification, in an example of the present disclosure.

FIG. 9 shows experimental results depicting 1× and 20× images of two nanofiber sheets, each stretched two and a half (2.5×) times the width of the as-drawn sheet and stacked so that individual nanofiber orientations were at 90° to one another, in an example of the present disclosure.

FIG. 10 shows images of the sample shown in FIG. 9 at 20× magnification, in an example of the present disclosure.

FIG. 11 shows experimental results depicting 1× and 20× images of two nanofiber sheets, each stretched to double (2×) the width of the as-drawn sheet and stacked so that individual nanofiber orientations were at 90° to one another, in an example of the present disclosure.

FIG. 12 shows images of the sample shown in FIG. 11 at 20× magnification, in an example of the present disclosure.

The figures depict various embodiments of the present disclosure for purposes of illustration only. Numerous variations, configurations, and other embodiments will be apparent from the following detailed discussion.

### DETAILED DESCRIPTION

### Overview

Carbon nanofiber sheets and yarns have an enormous technological potential. One feature of carbon nanofiber sheets that is of interest is their interesting electrical properties combined with transparency to some wavelengths of radiation. In some applications, a high degree of transparency to visible radiation wavelengths is desired. For some applications however, a nanofiber sheet drawn directly from a nanofiber forest may not have sufficient transparency. Techniques disclosed herein include methods for increasing transparency of a nanofiber sheet to many wavelengths of radiation, including those wavelengths within the visible spectrum.

Before describing the techniques of the present disclosure, nanofiber forests and sheets are described.

### Nanofiber Forests

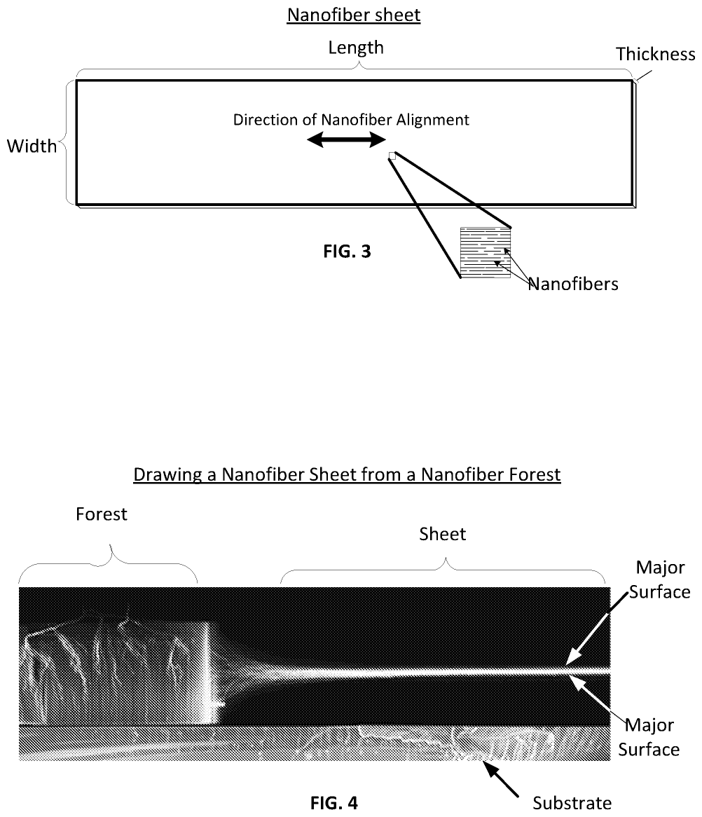

As used herein, the term “nanofiber” means a fiber having a diameter less than 1 μm. While the embodiments herein are primarily described as fabricated from carbon nanotubes, it will be appreciated that other carbon allotropes, whether graphene, micron or nano-scale graphite fibers and/or plates, and even other compositions of nano-scale fibers such as boron nitride. As used herein, the terms “nanofiber” and “carbon nanotube” encompass both single walled carbon nanotubes and/or multi-walled carbon nanotubes in which carbon atoms are linked together to form a cylindrical structure. In some embodiments, carbon nanotubes as referenced herein have between 4 and 10 walls. As used herein, a “nanofiber sheet” or simply “sheet” refers to a sheet of nanofibers aligned via a drawing process (as described in PCT Publication No. WO 2007/015710, and incorporated by reference herein in its entirety) so that a longitudinal axis of a nanofiber of the sheet is parallel to a major surface of the sheet, rather than perpendicular to the major surface of the sheet (i.e., in the as-deposited form of the sheet, often referred to as a “forest”). This is illustrated and shown in FIGS. 3 and 4, respectively.

The dimensions of carbon nanotubes can vary greatly depending on production methods used. For example, the diameter of a carbon nanotube may be from 0.4 nm to 100 nm and its length may range from 10 μm to greater than 55.5 cm. Carbon nanotubes are also capable of having very high aspect ratios (ratio of length to diameter) with some as high as 132,000,000:1 or more. Given the wide range of dimensional possibilities, the properties of carbon nanotubes are highly adjustable, or “tunable.” While many intriguing properties of carbon nanotubes have been identified, harnessing the properties of carbon nanotubes in practical applications requires scalable and controllable production methods that allow the features of the carbon nanotubes to be maintained or enhanced.

Due to their unique structure, carbon nanotubes possess mechanical, electrical, chemical, thermal and optical properties that make them well-suited for certain applications. In particular, carbon nanotubes exhibit superior electrical conductivity, high mechanical strength, good thermal stability and are also hydrophobic. In addition to these properties, carbon nanotubes may also exhibit useful optical properties. For example, carbon nanotubes may be used in light-emitting diodes (LEDs) and photo-detectors to emit or detect light at narrowly selected wavelengths. Carbon nanotubes may also prove useful for photon transport and/or phonon transport.

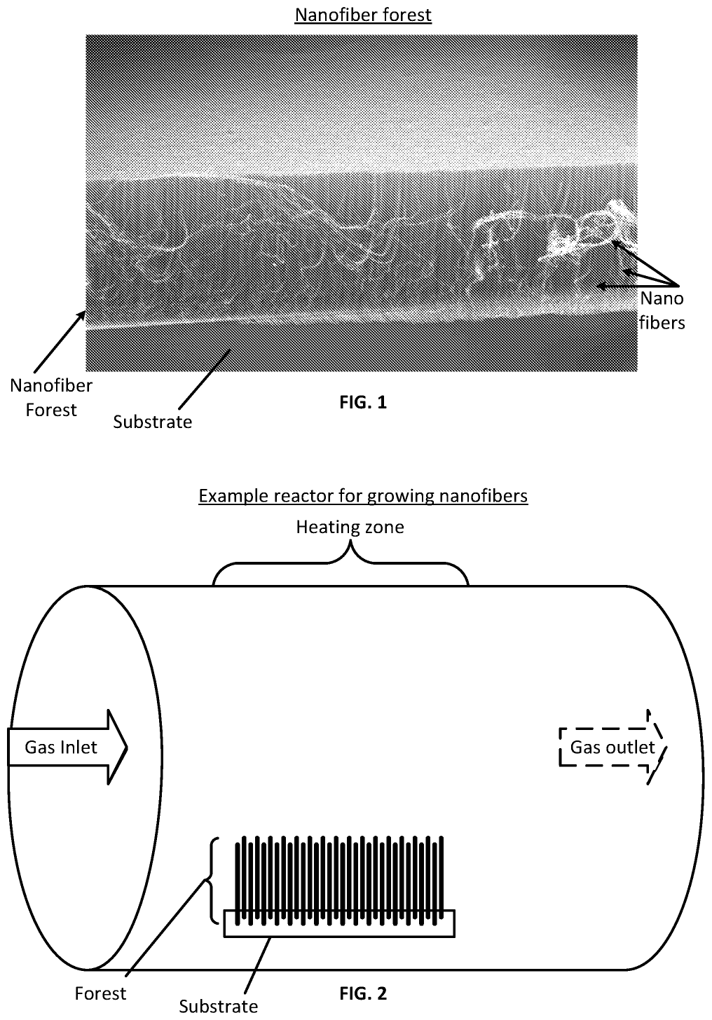

In accordance with various embodiments of the subject disclosure, nanofibers (including but not limited to carbon nanotubes) can be arranged in various configurations, including in a configuration referred to herein as a “forest.” As used herein, a “forest” of nanofibers or carbon nanotubes refers to an array of nanofibers having approximately equivalent dimensions that are arranged substantially parallel to one another on a substrate. FIG. 1 shows an example forest of nanofibers on a substrate. The substrate may be any shape but in some embodiments the substrate has a planar surface on which the forest is assembled. As can be seen in FIG. 1, the nanofibers in the forest may be approximately equal in height and/or diameter.

Nanofiber forests as disclosed herein may be relatively dense. Specifically, the disclosed nanofiber forests may have a density of at least 1 billion nanofibers/cm². In some specific embodiments, a nanofiber forest as described herein may have a density of between 10 billion/cm² and 30 billion/cm². In other examples, the nanofiber forest as described herein may have a density in the range of 90 billion nanofibers/cm². The forest may include areas of high density or low density and specific areas may be void of nanofibers. The nanofibers within a forest may also exhibit inter-fiber connectivity. For example, neighboring nanofibers within a nanofiber forest may be attracted to one another by van der Waals forces. Regardless, a density of nanofibers within a forest can be increased by applying techniques described herein.

Methods of fabricating a nanofiber forest are described in, for example, PCT No. WO2007/015710, which is incorporated herein by reference in its entirety.

Various methods can be used to produce nanofiber precursor forests. For example, in some embodiments, nanofibers may be grown in a high-temperature furnace, schematically illustrated in FIG. 2. In some embodiments, catalyst may be deposited on a substrate, placed in a reactor and then may be exposed to a fuel compound that is supplied to the reactor. Substrates can withstand temperatures of greater than 800° C. or even 1000° C. and may be inert materials. The substrate may comprise stainless steel or aluminum disposed on an underlying silicon (Si) wafer, although other ceramic substrates may be used in place of the Si wafer (e.g., alumina, zirconia, SiO², glass ceramics). In examples where the nanofibers of the precursor forest are carbon nanotubes, carbon-based compounds, such as acetylene may be used as fuel compounds. After being introduced to the reactor, the fuel compound(s) may then begin to accumulate on the catalyst and may assemble by growing upward from the substrate to form a forest of nanofibers. The reactor also may include a gas inlet where fuel compound(s) and carrier gasses may be supplied to the reactor and a gas outlet where expended fuel compounds and carrier gases may be released from the reactor. Examples of carrier gases include hydrogen, argon, and helium. These gases, in particular hydrogen, may also be introduced to the reactor to facilitate growth of the nanofiber forest. Additionally, dopants to be incorporated in the nanofibers may be added to the gas stream.

In a process used to fabricate a multilayered nanofiber forest, one nanofiber forest is formed on a substrate followed by the growth of a second nanofiber forest in contact with the first nanofiber forest. Multi-layered nanofiber forests can be formed by numerous suitable methods, such as by forming a first nanofiber forest on the substrate, depositing catalyst on the first nanofiber forest and then introducing additional fuel compound to the reactor to encourage growth of a second nanofiber forest from the catalyst positioned on the first nanofiber forest. Depending on the growth methodology applied, the type of catalyst, and the location of the catalyst, the second nanofiber layer may either grow on top of the first nanofiber layer or, after refreshing the catalyst, for example with hydrogen gas, grow directly on the substrate thus growing under the first nanofiber layer. Regardless, the second nanofiber forest can be aligned approximately end-to-end with the nanofibers of the first nanofiber forest although there is a readily detectable interface between the first and second forest. Multi-layered nanofiber forests may include any number of forests. For example, a multi-layered precursor forest may include two, three, four, five or more forests.

### Nanofiber Sheets

In addition to arrangement in a forest configuration, the nanofibers of the subject application may also be arranged in a sheet configuration. As used herein, the term “nanofiber sheet,” “nanotube sheet,” or simply “sheet” refers to an arrangement of nanofibers where the nanofibers are aligned end to end in a plane. An illustration of an example nanofiber sheet is shown in FIG. 3 with labels of the dimensions. In some embodiments, the sheet has a length and/or width that is more than 100 times greater than the thickness of the sheet. In some embodiments, the length, width or both, are more than 10³, 10⁶ or 10⁹ times greater than the average thickness of the sheet. A nanofiber sheet can have a thickness of, for example, between approximately 5 nm and 30 μm and any length and width that are suitable for the intended application. In some embodiments, a nanofiber sheet may have a length of between 1 cm and 10 meters and a width between 1 cm and 1 meter. These lengths are provided merely for illustration. The length and width of a nanofiber sheet are constrained by the configuration of the manufacturing equipment and not by the physical or chemical properties of any of the nanotubes, forest, or nanofiber sheet. For example, continuous processes can produce sheets of any length. These sheets can be wound onto a roll as they are produced.

As can be seen in FIG. 3, the axis in which the nanofibers are aligned end-to end is referred to as the direction of nanofiber alignment. In some embodiments, the direction of nanofiber alignment may be continuous throughout an entire nanofiber sheet. Nanofibers are not necessarily perfectly parallel to each other and it is understood that the direction of nanofiber alignment is an average or general measure of the direction of alignment of the nanofibers.

Nanofiber sheets may be assembled using any type of suitable process capable of producing the sheet. In some example embodiments, nanofiber sheets may be drawn from a nanofiber forest. An example of a nanofiber sheet being drawn from a nanofiber forest is shown in FIG. 4

As can be seen in FIG. 4, the nanofibers may be drawn laterally from the forest and then align end-to-end (with the nanofibers overlapping) to form a nanofiber sheet. In embodiments where a nanofiber sheet is drawn from a nanofiber forest, the dimensions of the forest may be controlled to form a nanofiber sheet having particular dimensions. For example, the width of the nanofiber sheet may be approximately equal to the width of the nanofiber forest from which the sheet was drawn. Additionally, the length of the sheet can be controlled, for example, by concluding the draw process when the desired sheet length has been achieved.

Nanofiber sheets have many properties that can be exploited for various applications. For example, nanofiber sheets may have tunable opacity, high mechanical strength and flexibility, thermal and electrical conductivity, and may also exhibit hydrophobicity. Given the high degree of alignment of the nanofibers within a sheet, a nanofiber sheet may be extremely thin. In some examples, a nanofiber sheet is on the order of approximately 10 nm thick (as measured within normal measurement tolerances), rendering it nearly two-dimensional. In other examples, the thickness of a nanofiber sheet can be as high as 200 nm or 300 nm. As such, nanofiber sheets may add minimal additional thickness to a component.

In some examples, nanofiber sheets can be exposed to a solvent (e.g., toluene, isopropyl alcohol, tetrahydrofuran, acetone, methanol, water, protic solvents, aprotic solvents, polar solvents, nonpolar solvents) that is subsequently removed. The exposure and subsequent removal can cause the constituent nanofibers within a nanofiber sheet to draw closer together. This “densification” can cause a thickness of the nanofiber sheet (including any of the values indicated above) to decrease by a factor of from 10 (for nanofiber sheets less than 100 nm thick) up to a factor of 1000 (for nanofiber sheets thicker than 100 nm).

As with nanofiber forests, the nanofibers in a nanofiber sheet may be functionalized by a treatment agent by adding chemical groups or elements to a surface of the nanofibers of the sheet and that provide a different chemical activity than the nanofibers alone. Functionalization of a nanofiber sheet can be performed on previously functionalized nanofibers or can be performed on previously unfunctionalized nanofibers. Functionalization can be performed using any of the techniques described herein including, but not limited to CVD, and various doping techniques.

Nanofiber sheets, as drawn from a nanofiber forest, may also have high purity, wherein more than 90%, more than 95% or more than 99% of the weight percent of the nanofiber sheet is attributable to nanofibers, in some instances. Similarly, the nanofiber sheet may comprise more than 90%, more than 95%, more than 99% or more than 99.9% by weight of carbon.

### Example Method

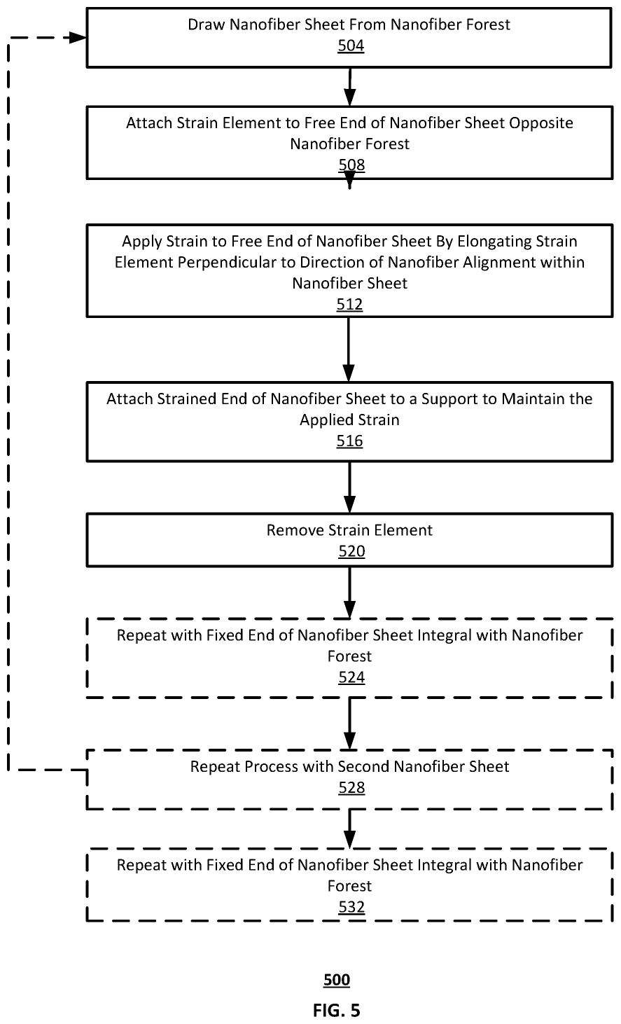

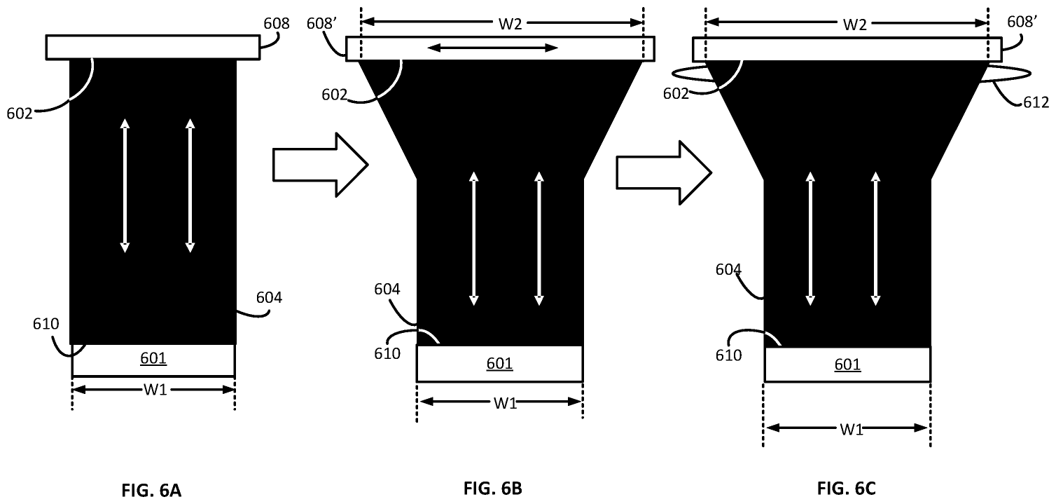

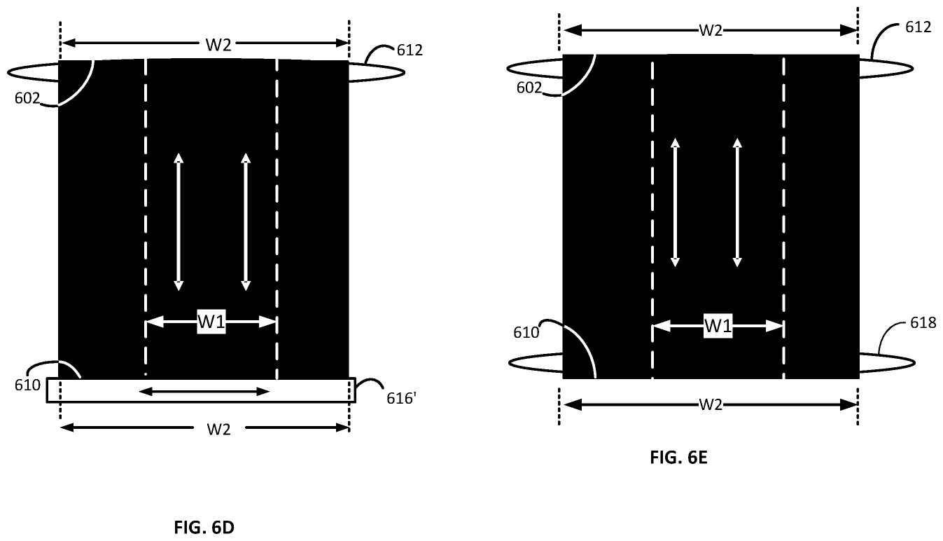

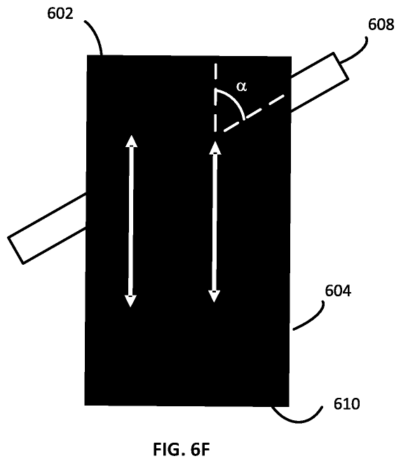

An example method 500 for increasing transparency of a nanofiber sheet is shown in FIG. 5. Some of the corresponding structures associated with various elements of the method 500 are illustrated in FIGS. 6A-6F. Concurrent reference between FIG. 5 and FIGS. 6A-6F will facilitate explanation.

The method 500 begins by drawing 504 a nanofiber sheet (604 in FIGS. 6A-6C) from a nanofiber forest (601 in FIGS. 6A-6C), as described above in the context of FIGS. 3 and 4.

A strain element can be attached 508 to the nanofiber sheet drawn from the nanofiber forest. This is shown in FIG. 6A as strain element 608 attached to a free end 602 of the nanofiber sheet 604 drawn from the nanofiber forest 601. A “fixed end” 610 of the nanofiber sheet 604 is attached to and integral with the nanofiber forest 601. A side view micrograph of this connection is shown in FIG. 4.

The strain element 608 can be attached 508 to a free end 602 of the nanofiber sheet 604 so that a direction of strainability of the strain element 608 is not parallel to the direction of alignment of nanofibers within the nanofiber sheet. This direction of nanofiber alignment is indicated in FIG. 6A by arrows, which also corresponds to the direction in which the nanofiber sheet is drawn from the nanofiber forest. In some examples, the strain element 608 can be attached 508 perpendicular to the direction of end to end alignment of individual nanofibers within the nanofiber sheet 604. This example is shown in FIG. 6A. In some examples the strain element 608 can be attached 508 at an angle α relative to the direction of alignment of nanofibers within the sheet that is from 45° to 135°. This is shown in FIG. 6F.

The strain element 608 can be attached 508 to the free end 602 of the nanofiber sheet 604 using, for example, adhesive tape, a curing adhesive (whether by air, radiation, or temperature), a compression fitting (e.g. a clamp or appropriately configured sleeve that holds the nanofiber sheet on the strain element 608), or a physical connection between the nanofiber sheet 604 and the strain element 608. Regardless of the method, however, the attachment should be sufficient to maintain the strain imposed (as described below) without fracturing or relaxing. In some examples, the attachment is releasable.

Examples of the strain element 608 include bands, rods, or sheets of elastomeric material or other material with a low elastic modulus. Examples of materials that can be used for the strain element 608 include, but are not limited to, elastomeric rubbers (e.g., butadiene rubber; elastomers having an elastic modulus less than 1 MPa, less than 0.5 MPa, less than 0.1 MPa, less than 50 kPa), plastically deformable polymers with low elastic moduli (e.g., less than 1 GPa or less than 2 GPa such as polyethylene), or even constructions of rigid material like steel that are configured for elongation (e.g., a telescoping steel rod).

Strain can then be applied 512 to the free end 602 of the nanofiber sheet 604 by elongating the strain element 608 in the strain direction. This straining is illustrated in FIG. 6B. While the strain element 608 is the same between the unstrained state shown in FIG. 6A and the strained state shown in FIG. 6B, the strain element in the latter figure is denoted 608′ to indicate that its shape has been changed (i.e., increased by straining) relative to its original state. The direction of elongation is indicated by a double-headed arrow within the strain element 608′. As indicated above, elongation of the strain element from 608 to 608′ can be caused by either plastic or elastic strain.

The applied strain produces the structure shown in FIG. 6B, in which a first width W1 of the as-drawn nanofiber sheet 604 (i.e., at the fixed end 610) is increased to a width W2 at the strained (free) end 602 where W2 is greater than W1. W2 can be within any of the following ranges of multiples of W1: 1.1 times (×) to 3× W1; from 1.5× to 3× W1; from 2× to 3× W1; from 1.5× to 2.5× W1. In some examples, 2.5× is also indicated as “150%” and 3× is indicated as “200%.”

The strained end (also corresponding to the free end 602 in FIGS. 6B-6E) can then be attached 516 to an inelastic support 612 so as to maintain the strain imposed on the nanofiber sheet 604 at the free end 602 by the strain element 608′. This is shown in FIG. 6C. The attachment between the inelastic support 612 and the nanofiber sheet 604 having a width W2 can use any of the techniques described above or alternatively can use a permanent adhesive. Once attached 516 to the support 612, the strain element 608′ can be removed 520 either by reversing the previously described connection or simply severing the nanofiber sheet between the support 612 and the strain element 608 in cases where the support 612 has been placed between the strain element 608 and the fixed end 610 of the sheet 604.

Examples of the inelastic support 612 can include rods, pins, bars, hoops or other structures that have an elastic modulus that can resist elastic deformation during routine handling. The inelastic support 612 can also include a frame that is able to secure the free end 602, the fixed end 610, and (optionally) opposing intervening sides while leaving a center portion of the nanofiber sheet unsupported. Example materials that can be used to form the inelastic support 612 include, but are not limited to, polymers (e.g., polycarbonate, polyethylene, polytetrafluorethylene), metals (steel, copper, aluminum), glass (silica glass, borosilicate glass), silicon, among others.

The preceding elements of the method 500 can then be repeated 524 with the fixed end 610 of the nanofiber sheet 604. The repetition of elements 512, 516 to the fixed end 610 of the nanofiber sheet 604 are shown in FIGS. 6D, 6E. The original width W1 of the as-drawn nanofiber sheet (prior to straining) is indicated in FIG. 6E. The strain element associated with end 610 is shown in its strained state (as indicated by the double-headed arrow therein) and is labeled at strain element 616′. The inelastic support maintaining the strain at the end 610 is indicated at inelastic support 618.

The method 500 can be repeated 528 by drawing a second nanofiber sheet from the nanofiber forest 601 to produce a second stretched nanofiber sheet. In some examples, the method 500 may optionally continue by stacking 532 the second nanofiber sheet on the first nanofiber sheet. The direction of nanofiber alignment between the stacked sheets can be from 5° to 185° relative to one another. Generally, the alignment between the two is not 0° (i.e., they are not stacked so as to have parallel nanofiber alignments). In experimental examples described below, the two sheets are stacked to have perpendicular nanofiber alignments. The stacking can be repeated with any number of nanofiber sheets and any of the orientations indicated above.

As described below, performance of the method can cause an increase in transparency of the nanofiber sheets to radiation. In some cases, it has been observed that the increased transparency is caused by gaps forming within the strained nanofiber sheet. In some examples, multiple strained nanofiber sheets can be stacked on one another. In some cases, the stacking of multiple strained sheets can improve the mechanical stability and toughness of the stack relative to an individual nanofiber sheet. While experimental examples described below indicate stacking the sheets so that the direction of nanofiber alignment between the two sheet are perpendicular to one another (+/−5°), it will be appreciated that the stacked sheets can be oriented at any orientation relative to one another.

### Properties

Performance of the method 500 can increase a width of an as-drawn nanofiber sheet from a first width (W1) to a second width (after straining, W2) by up to a factor of 3. In other words, the width of the stretched sheet is increased by a factor of 3 (or “3×”). Equivalently, this can be expressed W2=3*(W1). In other examples, performance of the method 500 can create a second width W2 greater than the first width (W1) of the as-drawn nanofiber within any of the following ranges: from 1.1× to 2×; from 1.1× to 2.5×; from 1.5× to 2×; from 2.5× to 3×; from 1.75× to 3×.

In some examples, a transparency in the visible radiation spectrum (e.g., having a wavelength from 380 nm to 740 nm, from 400 nm to 700 nm, from 450 nm to 550 nm) can be increased for a single nanofiber sheet by 10% to 15%. In other words, a single carbon nanofiber sheet 604 can have a transparency in the visible spectrum of approximately 80% before stretching (e.g., at a width of W1) and a transparency of at least 95% after stretching (e.g., to a width of W2).

In some examples, gaps may form within the sheet upon stretching. The formation of these gaps can be a function of, in part, nanofiber forest height and density from which the nanofiber sheet is drawn. For a short forest (e.g., a height of less than 150 μm) or a less dense forest (e.g., 45-50 mg/cm³) the gaps in the sheet will be uniformly sized and distributed until the width has increased to 1.5× the width of the original sheet. A sheet from a tall forest (e.g., between 300 μm and 500 μm) or a dense forest (e.g., greater than 60 mg/cm³) can have uniformly sized and distributed gaps up to about 1.65× the original sheet width.

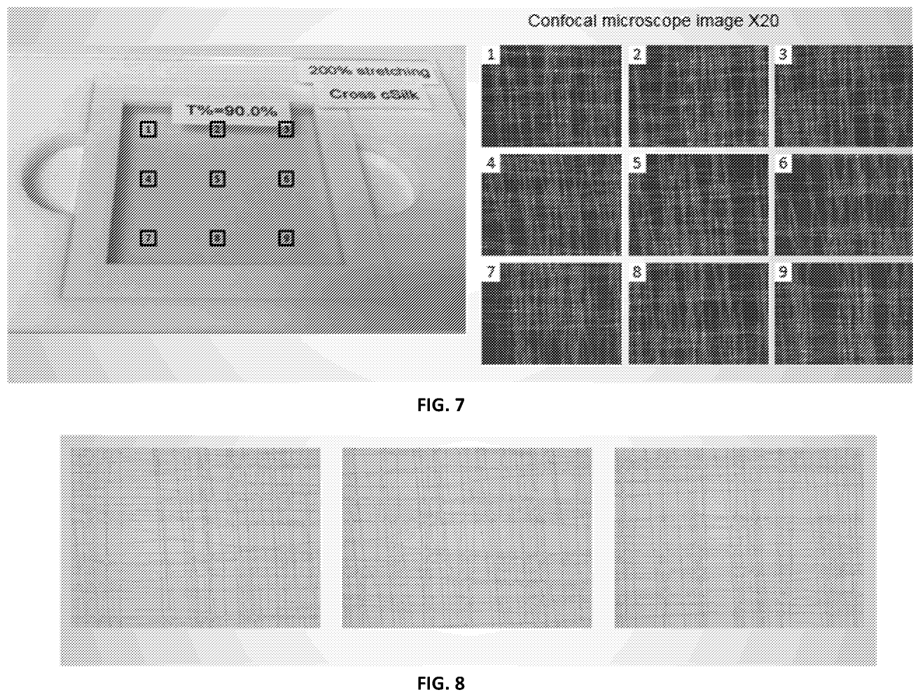

Experimental results of transparencies versus and extent of stretching appear below in Table 1. Experimental results 1-3 describe the percent (%) transmission of visible spectrum radiation for two nanofiber sheets stretched the indicated amount and stacked with the nanofiber orientation in the sheets 90° to one another. Experimental result 4 included unstretched sheets stacked at 90° to one another, thus acting as a reference point for the Experimental Results 1-3 processed according to the techniques described above. It will be appreciated in light of FIGS. 7-12 that the gap width dimensions presented below in Table 1 correspond to a length of a side of the (approximately rectangular) gap and not a diagonal of the gap.

TABLE 1

| | Stretch | | | Gap Width |
|---|---|---|---|---|
| | (multiple of | % | | Variation |
| Sample | as-drawn | Trans- | Average Gap | (+/− avg. |
| No. | sheet width) | parency | Width (μm) | value in μm) |
| 1 | 3 | 90 | 26.9 | 18.2 |
| 2 | 2.5 | 88.3 | 24.7 | 26.2 |
| 3 | 2 | 86.2 | 19.3 | 9.2 |
| 4 | 1 | 73%-78% | 14.4 | 5.2 |

FIG. 7 shows experimental results depicting 1× and 20× images of two nanofiber sheets, each stretched to three times the original width of the as-drawn sheet and stacked so that individual nanofiber orientations were at 90° to one another, in an example of the present disclosure. FIG. 8 shows images of the sample shown in FIG. 7 at 20× magnification, in an example of the present disclosure. These images correspond to sample number 1 in Table 1.

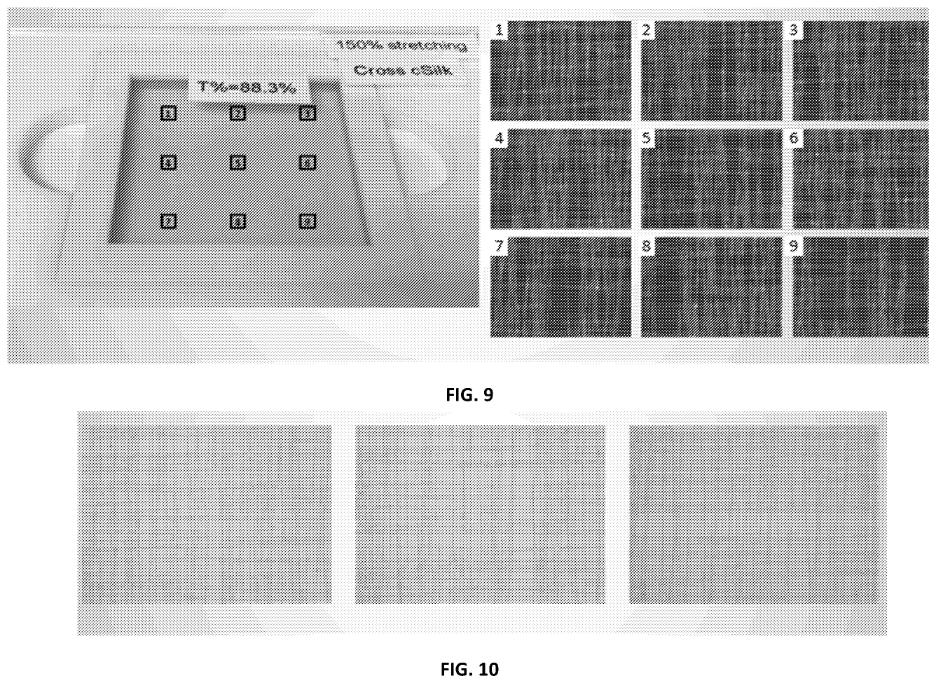

FIG. 9 shows experimental results depicting 1× and 20× images of two nanofiber sheets, each stretched 2.5 times the original width of the as-drawn sheet and stacked so that individual nanofiber orientations were at 90° to one another, in an example of the present disclosure. FIG. 10 shows images of the sample shown in FIG. 9 at 20× magnification, in an example of the present disclosure. These images correspond to sample number 2 in Table 1.

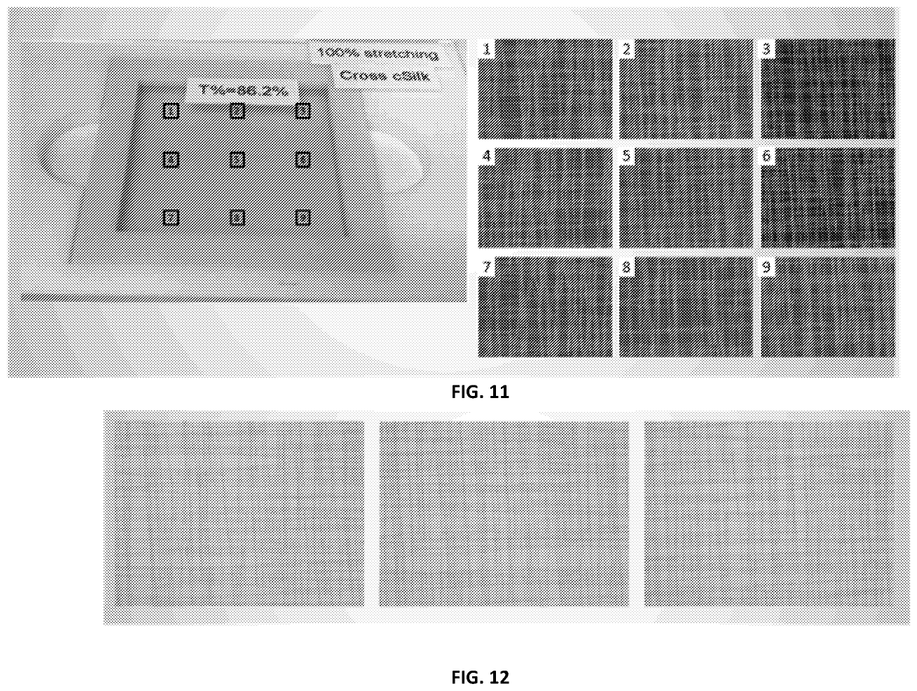

FIG. 11 shows experimental results depicting 1× and 20× images of two nanofiber sheets, each stretched twice the original width of the as-drawn sheet and stacked so that individual nanofiber orientations were at 90° to one another, in an example of the present disclosure. FIG. 12 shows images of the sample shown in FIG. 11 at 20× magnification, in an example of the present disclosure. These images correspond to sample number 3 in Table 1.

The images in FIGS. 7-11 were captured using a confocal microscope. Some of the images were captured using bright field microscopy techniques and some were captured using dark field microscopy techniques.

### FURTHER CONSIDERATIONS

The foregoing description of the embodiments of the disclosure has been presented for the purpose of illustration; it is not intended to be exhaustive or to limit the claims to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the embodiments is intended to be illustrative, but not limiting, of the scope of the invention, which is set forth in the following claims.

1. A method comprising:
drawing a first nanofiber sheet from a nanofiber forest, the first nanofiber sheet having a fixed end integral with the nanofiber forest and a free end opposite the fixed end, wherein a plurality of nanofibers of the first nanofiber sheet are aligned with a drawing direction of the first nanofiber sheet; attaching a strain element to the free end;
applying strain to the free end by elongating the strain element in a direction not parallel to the alignment of the nanofibers;
attaching the strained free end of the nanofiber sheet to a support, the support maintaining the applied strain in the first nanofiber sheet;
removing the first nanofiber sheet from the nanofiber forest; and
stacking a second nanofiber sheet on the first nanofiber sheet.

2. The method of claim 1, further comprising:
drawing the second nanofiber sheet from the nanofiber forest, the second nanofiber sheet having a second fixed end integral with the nanofiber forest and a second free end opposite the second fixed end, wherein a plurality of nanofibers of the second nanofiber sheet are aligned with the drawing direction of the second nanofiber sheet;
attaching the strain element to the second free end;
applying strain to the second free end by elongating the strain element in a second direction not parallel to the orientation of the nanofibers;
attaching the second strained, free end of the second nanofiber sheet to a second support, the second support maintaining the applied strain in the second nanofiber sheet; and
removing the second nanofiber sheet from the nanofiber forest.

3. The method of claim 1, further comprising forming a plurality of gaps in one or both of the first nanofiber sheet and the second nanofiber sheet in response to applying the strain.

4. The method of claim 3,
wherein an average gap size of the gaps is from 8 microns on a side to 45 microns on a side, and
wherein:
applying the strain to the first nanofiber sheet and the second nanofiber sheet comprises straining each sheet by a factor of 3; and
a transparency of the stacked first nanofiber sheet and the second nanofiber sheet to radiation in the visible spectrum is 90%.

5. (canceled)

6. The method of claim 2, wherein a transparency of the stack of the first nanofiber sheet and the second nanofiber sheet to radiation having a wavelength of 550 nm is from 72% to 88%.

7. The method of claim 2, wherein the first nanofiber sheet and the second nanofiber sheet are stacked relative to have their corresponding nanofiber alignment directions not parallel to one another.

8. The method of claim 1, wherein an angle between nanofiber alignment directions of the first nanofiber sheet and the second nanofiber sheet are from 45° to 135°, excluding 0°.

9. The method of claim 1,
wherein the second nanofiber sheet is in an as-drawn state, and
wherein the method further comprises densifying the second nanofiber sheet by exposing the second nanofiber sheet to a solvent and removing the solvent before the stacking.

10. (canceled)

11. A method comprising:
drawing a nanofiber sheet from a nanofiber forest, the nanofiber sheet having a fixed end integral with the nanofiber forest and a free end opposite the fixed end, wherein a plurality of nanofibers of the nanofiber sheet are aligned in a direction parallel to a drawing direction of the nanofiber sheet;
attaching a strain element to the free end;
applying strain to the free end by elongating the strain element in a direction not parallel to the alignment of the nanofibers; and
attaching the strained, free end of the nanofiber sheet to a support, the support maintaining the applied strain in the nanofiber sheet.

12. The method of claim 11, further comprising removing the strain element from the strained free end.

13. The method of claim 11, further comprising applying the method of claim 11 to the fixed end of the nanofiber sheet.

14. The method of claim 13, further comprising severing the fixed end from the nanofiber forest after applying the strain to the fixed end.

15. The method of claim 11, wherein the strain is applied in a direction from 45° to 135° relative to the direction of alignment of the nanofibers within the nanofiber sheet.

16. The method of claim 11, wherein the nanofiber sheet has a first width prior to straining and a second width after straining, the second width greater than the first width.

17. The method of claim 16, wherein the second width is from 2.5 times to 3 times the first width.

18. The method of claim 16, wherein a transparency to radiation having a wavelength of 550 nm is at least 80%.

19. A transparent nanofiber sheet produced by a method comprising:
drawing a nanofiber sheet from a nanofiber forest in a drawing direction, the nanofiber sheet having a fixed end integral with the nanofiber forest and a free end opposite of the fixed end, wherein a plurality of nanofibers of the nanofiber sheet is aligned in an alignment direction that is parallel with the drawing direction;
attaching a strain element to the free end;
elongating the strain element in a direction different from the alignment direction, such that a width of the free end is increased to be larger than a width of the fixed end;
attaching the elongated free end to an inelastic support; and
removing the nanofiber sheet from the nanofiber forest.

20. The transparent nanofiber sheet produced by the method of claim 19, wherein the width of the free end is 2.5 times to 3 times wider than the width of the fixed end.

21. The transparent nanofiber sheet produced by the method of claim 19, wherein the width of the free end is 1.5 times to 2 times wider than the width of the fixed end.

22. The transparent nanofiber sheet produced by the method of claim 19, wherein the width of the free end is 1.1 times to 2.5 times wider than the width of the fixed end.

23. The transparent nanofiber sheet produced by the method of claim 19, wherein a transparency in a visible radiation spectrum of the free end of the nanofiber sheet is 10% to 15% greater than the fixed end of the nanofiber sheet.

24. The transparent nanofiber sheet produced by the method of claim 19, wherein the plurality of nanofibers includes multi-walled nanofibers.

25. The transparent nanofiber sheet produced by the method of claim 19,
wherein the produced transparent nanofiber sheet includes:
a first end having a first width;
a second end having a second width that is greater than the first width; and
the inelastic support attached to the second end, the inelastic support configured to maintain a strain applied to the second end, wherein the strain is applied in a strain direction different from the alignment direction of the plurality of nanofibers forming the nanofiber sheet,
wherein a transparency in a visible radiation spectrum of the second end of the nanofiber sheet is greater than the first end of the nanofiber sheet.
